(19) United States
(12) Patent Application Publication
(10) Pub. No.: US 2026/0313773 A1
(43) Pub. Date: Oct. 8, 2026

(54) ARRANGEMENT COMPRISING A CONTROL DEVICE AND A PLURALITY OF SMART INTEGRATED CIRCUITS FOR CONTROLLING ELECTRICAL OR ELECTRONIC COMPONENTS

(71) Applicant: HELLA GMBH & CO. KGAA, Lippstadt (DE)

(72) Inventor: Peter Rölleke, Marsberg (DE)

(21) Appl. No.: 19/634,292

(22) Filed: Mar. 31, 2026

(30) Foreign Application Priority Data
Apr. 3, 2025 (DE) 102025113081.7

(51) Int. Cl. H05B 47/18; B60Q 1/04

(52) U.S. Cl. CPC H05B 47/18; B60Q 1/04

(57) ABSTRACT

An arrangement for controlling electrical or electronic devices is provided. The arrangement includes a control device, a plurality of smart integrated circuits configured to control the electrical or electronic components, and a communication bus between the control device and the smart integrated circuits. Each smart integrated circuit includes an activation port, an output port configured to indicate activation, at least one communication port for communication via the bus, a mode port configured to specify an operating mode, and at least one output port configured to connect to an electrical or electronic component. The control device includes a plurality of ports including at least one communication port configured for communication with the smart integrated circuits via the bus.

### CROSS-REFERENCE TO RELATED APPLICATIONS

This application claims the benefit of German Patent Application 10-2025-113-081.7, filed Apr. 3, 2025, the disclosure of which is incorporated by reference in its entirety.

### FIELD OF THE INVENTION

The invention relates to an arrangement comprising a control device, a plurality of smart integrated circuits (smart ICs) for controlling electrical or electronic components and a bus for communication between the control device and the integrated circuits.

### BACKGROUND OF THE INVENTION

Arrangements comprising a control device, a microcontroller for controlling electrical or electronic components and a bus for communication between the control device and the microcontroller are known from the prior art. The electrical or electronic components are connected to the microcontroller. Each component is assigned an address and the microcontroller and the components can communicate via the bus using these addresses. In particular, the control device can send control instructions to the components and these can receive the instructions. The components can in turn transmit sensor variables to the microcontroller, for example.

In recent years, smart integrated circuits, so-called smart ICs, have replaced microcontrollers in various application areas, including automotive technology. However, a problem arises in an architecture comprising a control device, a microcontroller connected to the control device and several components connected thereto, when this microcontroller which performs various functions and controls these different components, is to be replaced by several (possibly identical) smart ICs. For example, in a headlight arrangement with a control device, a microcontroller, a connection between the control device and the microcontroller and the components connected to the microcontroller, the microcontroller cannot simply be replaced by identical smart ICs. It must therefore be ensured that the smart ICs can be addressed by the control device so that the component connected to the respective Smart IC can be controlled.

Arrangements comprising a control device, a microcontroller for controlling electrical or electronic components and a bus for communication between the control device and the microcontroller can be used for different purposes with the same (electrical or electronic) topology. The purpose for which the arrangement is used can be determined by coding or programming. For example, headlamp arrangements of this type can be used as right headlamps on the right-hand side of a vehicle or as left headlamps on the left-hand side of a vehicle. For coding or programming, a resistor element is connected to a port of the microcontroller, which specifies an operating mode of the microcontroller. The voltage preset at the port of the microcontroller via this element enables the microcontroller to determine what type of arrangement or headlight it should be, namely a right or a left headlight. The microcontroller can then also communicate this to the control device, which sends control signals to the microcontroller according to its use in the right or left headlight. In known headlight arrangements, the resistor element is integrated in a plug connector via which the components connected to the microcontroller are connected to the microcontroller.

In a topology in which the microcontroller is replaced by preferably identical smart ICs, care must be taken firstly to ensure that the control device is informed of the purpose for which the arrangement is to be used, and secondly to ensure that the control device controls the smart ICs in accordance with the purpose. If the same components in a similar topology are to be controlled not via a microcontroller but via several smart ICs, it must be ensured that all smart ICs receive the correct instructions from the control device for their function according to the use of the arrangement.

### SUMMARY OF THE INVENTION

The object of the present invention is to propose an arrangement of the type mentioned above, in which it is ensured that the control device is informed of the purpose for which the arrangement is to be used and how the individual smart ICs can be addressed.

According to the invention, this object is achieved by an arrangement having the features of the disclosed embodiments. Accordingly, an arrangement of the type described above has the following features. Each of the smart integrated circuits has several ports, including: one port for activating the smart integrated circuit; a port that indicates that the smart integrated circuit has been activated; at least one port for connection to a bus for communication between the control device and the smart integrated circuit; a port for specifying an operating mode of the smart integrated circuit; and at least one port for connecting the smart integrated circuit to an electrical or electronic component. The control device has a plurality of ports, including at least one port for connection to a bus for communication between the control device and the smart integrated circuit. A first of the smart integrated circuits is configured such that: the operating mode specified for the first smart integrated circuit determines an address of the first smart integrated circuit, and the first smart integrated circuit can be addressed by the control device via the bus using this address; and the first smart integrated circuit communicates to the control device via the bus which operating mode is specified or which address has been selected for the first smart integrated circuit. Each n-th smart integrated circuit with n>is connected with its port for activating the n-th smart integrated circuit to the port of the (n-1)-th smart integrated circuit, which indicates activation of the (n-1)-th smart integrated circuit when the (n-1)-th smart integrated circuit is activated.

Each n-th smart integrated circuits with n>1 can be configured such that after activation of the n-th smart integrated circuit, this n-th smart integrated circuit is assigned an address by the control device via the bus depending on the operating mode or address transmitted to the control device by the first smart integrated circuit. Alternatively, it is possible that the operating mode of each of the n-th smart integrated circuits can be determined, like the purpose of the arrangement, via the port for specifying the operating mode of the first smart integrated circuit. At the port for specifying the operating mode of the nth smart integrated circuit, the operating mode of the nth smart integrated circuit can be determined permanently rather than just temporarily.

This arrangement can in principle be used for various purposes. The purpose of the arrangement can be determined via the port for specifying the operating mode of the first smart integrated circuit. Based on the specified operating mode, an address is determined for the first smart integrated circuit, i.e., the first smart IC, and this address is communicated to the control device. Based on the determined address, the control device now recognizes the purpose for which the arrangement is intended. In addition, the first smart IC activates the second smart IC via a port that indicates the activation of the first smart IC when it is activated and that is connected to the port for activating the second smart IC. The second smart IC initially has a default address. The second smart IC registers with the control device and receives from the control device an address corresponding to the function of the second smart IC in the arrangement. The second smart IC replaces the default address with the newly assigned address and can then be addressed at this new address. As soon as the second smart IC is reachable at this new address, it activates the third smart IC via its port that indicates activation of the second smart IC and that is connected to the port for activating the third smart IC. The third smart IC is then assigned an address and a function in the same manner as the second smart IC. All further smart ICs are then assigned an address and a function sequentially in the same manner until the last smart IC in the arrangement has been activated and assigned an address and a function by the control device.

According to the invention, the arrangement for connecting a component connectable to the first smart integrated circuit may comprise at least a first connector part. If the arrangement then also has the component that can be controlled by the first integrated circuit, this controllable component may comprise a second connector part that is connected to the control device via the first connector part. A coding element can then be provided in the second plug connector part, which can be connected via the first plug connector part to the port for specifying an operating mode of the first smart integrated circuit. This coding element can be used to specify the operating mode of the first smart integrated circuit. The coding element may be a resistor element that sets a voltage relative to a reference potential at the port for specifying the operating mode of the first smart integrated circuit or a current via the port for specifying the operating mode. This potential or current present at the port can then determine the operating mode.

According to the invention, the port for specifying an operating mode of an n-th smart integrated circuit with n >1 may be connected to the reference potential of the arrangement via a resistor. This resistor can be the coding element that specifies the operating mode of the first smart integrated circuit.

The electrical or electronic components of an arrangement according to the invention may include light sources. The electrical or electronic components of an arrangement according to the invention may also include all other components of a headlight, in particular a headlight for a motor vehicle, in particular a car or a truck. An arrangement according to the invention can thus form a headlight according to the invention.

According to the invention, a pair of headlights comprising two headlights according to the invention may also be provided. The coding element of one headlight may then be different from that of the other headlight. This allows specification that one headlight is a right headlight and the other headlight is a left headlight.

### BRIEF DESCRIPTION OF THE DRAWING

An arrangement according to the invention is explained in more detail below with reference to a drawing. The drawing shows:

FIG. 1 is a schematic representation of a part of an arrangement according to the invention.

### DETAILED DESCRIPTION

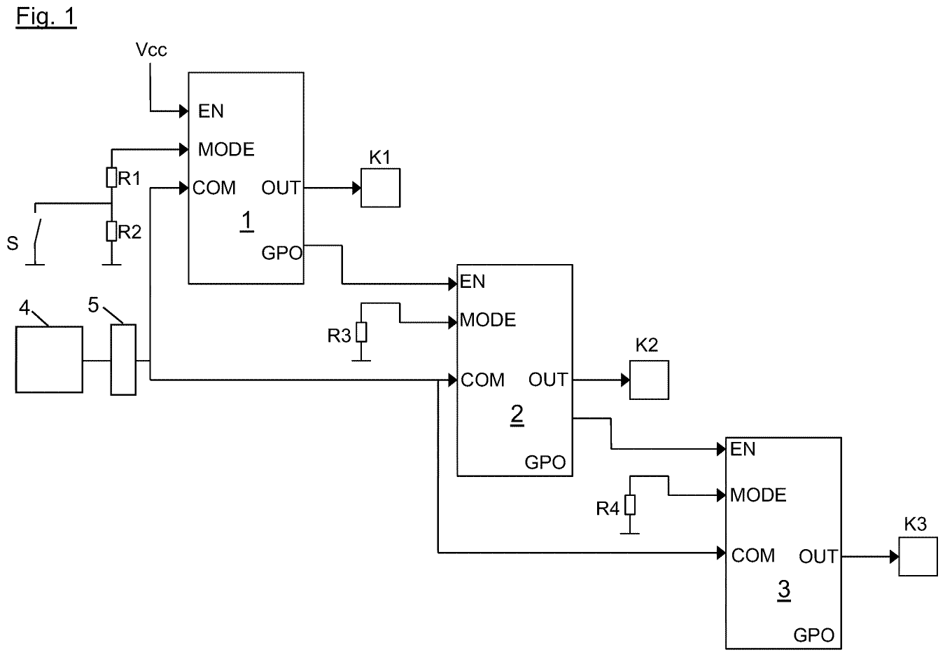

The part of an arrangement according to the invention shown in FIG. 1 comprises three smart ICs 1, 2, 3. These three smart ICs 1, 2, 3 are identical. Each smart integrated circuit comprises: an IN port for activating the smart integrated circuit; a MODE port for specifying an operating mode of the smart integrated circuit; a COM port for a bus 5 for communication between the control device 4 and the smart integrated circuit; an OUT port for connecting the smart integrated circuit to an electrical or electronic component; and a GPO port that indicates the activation of the smart integrated circuit when the circuit is activated.

A first smart IC 1 of the three smart ICs 1, 2, 3 is connected via its EN port to a voltage supply VCC for activation. As soon as the voltage supply VCC is switched on, the first smart IC 1 is activated.

The MODE port for specifying an operating mode of the first Smart IC 1 is connected to the reference potential of the arrangement via a voltage divider consisting of two resistor elements R1, R2. A node between the two resistors R1, R2 is also connected to the reference potential of the arrangement via a switch S. Depending on the position of switch S, the MODE port for specifying the operating mode of the first smart IC 1 is connected to the reference potential, i.e., only via the resistor element R1 or via the series connection of the resistor elements R1, R2. This is used to specify the operating mode of the first smart IC. If a voltage generated by the smart IC 1 is present at the MODE port for specifying the operating mode, a high or low voltage will be present at the MODE port depending on the position of switch S. Based on the resulting voltage, which can be detected in the smart IC 1, The smart IC 1 can recognize which operating mode is specified by the position of switch S. When the operating mode is specified, an address is also specified for the first smart IC 1, via which the first smart IC 1 can be addressed over the bus 5. Both the operating mode and the address are communicated to the control device 4 by the first smart IC 1.

The operating mode specified for the first smart IC 1 determines the operating mode and address of the second and third smart ICs 2, 3. The operating mode and the address are communicated to the second and third smart ICs 2, 3 by the control device 4. This is explained in more detail below.

A second smart IC 2 of the three smart ICs 1, 2, 3 is connected via its EN port for activation to the GPO port of the first smart IC 1, which indicates activation when the first smart IC 1 is activated. As soon as activation of the first smart IC 1 is indicated to the second smart IC 2 at the GPO port, the second smart IC 2 is activated.

The MODE port for specifying an operating mode of the second smart IC 2 is connected to the reference potential of the arrangement via a resistor element R3. The resistor element R3 sets a voltage at the MODE port of the second smart IC 2. After activation of the second smart IC 2, this voltage initially determines a temporary assignment of an operating mode and an address of the second smart IC 2, namely the default address. As soon as the control device 4 has recognized the activation of the second smart IC 2, the control device 4 assigns an address and an operating mode to the second smart IC 2. This overwrites the operating mode and the default address initially specified by the resistor element R3. As soon as this has occurred, the activation of the second smart IC 2 is indicated at the GPO port.

A third smart IC 3 of the three smart ICs 1, 2, 3 is connected via its EN port for activation to the GPO port of the second smart IC 2, which indicates activation of the second smart IC 2 once the second smart IC 2 has been activated and assigned an address and operating mode by the control device 4. As soon as activation of the second smart IC 2 is indicated to the third smart IC 3 at the GPO port, the third smart IC 3 is activated.

The MODE port for specifying an operating mode of the third smart IC 3 is also connected to the reference potential of the arrangement via a resistor element, namely the resistor element R4. The resistor element R4 sets a voltage at the MODE port of the third smart IC 3. After activating the third smart IC 3, this initially determines a temporary assignment of an operating mode and an address for the third smart IC 3, namely a default address. As soon as the control device 4 has recognized the activation of the third smart IC 3, the control device 4 assigns an address and an operating mode to the third smart IC 3. This overwrites the operating mode and default address initially specified by the resistor element R4.

Via the COM port for a bus 5 used for communication between the control device 4 and the first, second and third smart IC 1, 2, 3 (and possibly further smart ICs in other arrangements according to the invention), the first, second and third smart IC 1, 2, 3 are connected to the control device 4 and the first, second and third smart IC 1, 2, 3 can receive signals and send signals to the control unit via the bus 5 and the COM port. For example, the first, second and third smart ICs 2, 3 can receive control signals and/or signals for configuring the first, second and third smart ICs 2, 3 of the control device 4 and/or send sensor signals to the control device 4. For example, the address and operating mode can be assigned to the second and third smart ICs 2, 3 by the control device 4.

The first, second and third smart ICs 1, 2, 3 are connected to a first electrical or electronic component K1, a second electrical or electronic component K2 and a third electrical or electronic component K3, respectively, via the OUT port. The smart ICs 1, 2, 3 can control these components K1, K2, K3 via these OUT ports.

### LIST OF REFERENCE SYMBOLS

1 first smart IC
2 second smart IC
3 third smart IC
4 control device
5 bus
EN port for activating the smart integrated circuits
MODE port for specifying an operating mode for the smart integrated circuits
COM port for a bus for communication between the control device and the smart integrated circuits
OUT port for connecting the smart integrated circuits to an electrical or electronic component
GPO port that indicates activation of the smart integrated circuits when they are activated
R1 first resistor element
R2 second resistor element
R3 third resistor element
R4 fourth resistor element
S operating mode switch
K1 first electrical or electronic component (e.g., light source(s))
K2 second electrical or electronic component (e.g., light source(s))

K3 third electrical or electronic component (e.g., light source(s))

The above description is that of current embodiments of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments. Any reference to elements in the singular, for example, using the articles “a,” “an,” “the,” or “said,” is not to be construed as limiting the element to the singular.

1. An arrangement comprising:
a plurality of smart integrated circuits for controlling electrical or electronic components; and
a bus for communication between the smart integrated circuits and a control device,
wherein each of the smart integrated circuits includes a plurality of ports including: an activation port configured to activate the smart integrated circuit; an output port configured to indicate activation of the smart integrated circuit; a communication port configured for communication with the control device via the bus; a mode port configured to specify an operating mode of the smart integrated circuit; and an output port configured to connect the smart integrated circuit to an electrical or electronic component,
wherein the control device includes at least one communication port configured for communication with the smart integrated circuits via the bus,
wherein a first one of the smart integrated circuits is configured such that: the operating mode specified for the first smart integrated circuit determines an address of the first smart integrated circuit such that the control device addresses the first smart integrated circuit via the bus using the address; and the first smart integrated circuit communicates to the control device via the bus which operating mode is specified or which address is selected, and
wherein each n-th smart integrated circuit, where n is greater than 1, has an activation port connected to a port of an (n−1)-th smart integrated circuit that indicates activation of the (n−1)-th smart integrated circuit when the (n−1)-th smart integrated circuit is activated.

2. The arrangement of claim 1, wherein each n-th smart integrated circuit, where n is greater than 1, is configured such that, after activation, the n-th smart integrated circuit is assigned an address by the control device via the bus as a function of the operating mode or address transmitted to the control device by the first smart integrated circuit.

3. The arrangement of claim 1, further comprising at least one first connector part configured for connecting a component to the first smart integrated circuit.

4. The arrangement of claim 3, further comprising:
a component controllable by the first smart integrated circuit, the component being connected to the control device via a second connector part and the first connector part, wherein a coding element is provided in the second connector part, the coding element being connected via the first connector part to the mode port of the first smart integrated circuit, and, wherein the coding element specifies the operating mode of the first smart integrated circuit.

5. The arrangement of claim 1, wherein the mode port of each n-th smart integrated circuit, where n is greater than 1, is connected to a reference potential via a resistor.

6. A headlight comprising the arrangement of claim 1, wherein the electrical or electronic components include light sources.

7. A pair of headlights comprising:
a first headlight according to claim 6; and
a second headlight according to claim 6,
wherein a coding element of the first headlight is different from a coding element of the second headlight, and
wherein one of the headlights is a right headlight and the other headlight is a left headlight.
